(19) United States
(12) Patent Application Publication
(10) Pub. No.: US 2024/0228834 A9
(43) Pub. Date: Jul. 11, 2024

(54) MULTILAYER ADHESIVE STRIP WITH FOAMED SUBSEQUENTLY APPLIED COMPOUNDS FOR IMPROVING COLD SHOCK RESISTANCE

(71) Applicant: tesa SE, Nordersteat (DE)

(72) Inventors: Thilo DOLLASE, Hamburg (DE); Hans Peter GRAEF, Hamburg (DE); Michael MAYER, Hamburg (DE); Anika PETERSEN, Heidmuehlen (DE); Thomas SCHUBERT, Norderstedt (DE)

(73) Assignee: tesa SE, Norderstedt (DE)

(21) Appl. No.: 18/278,469

(22) PCT Filed: Feb. 23, 2022
(86) PCT No.: PCT/EP2022/054584

§ 371 Date: Aug. 23, 2023

(30) Foreign Application Priority Data
Feb. 23, 2021 (DE) 10 2021 201 684.7

(51) Int. Cl. C09J 7/38; C09J 7/26

(52) U.S. Cl. CPC C09J 7/385; C09J 7/26; C09J 7/383; C09J 2203/354; C09J 2301/408; C09J 2301/41; C09J 2301/412; C09J 2400/243; C09J 2433/006

(57) ABSTRACT

The invention relates to a multilayer adhesive strip comprising a carrier layer and at least one adhesive layer arranged on the carrier layer, wherein the carrier layer comprises a syntactically foamed plastic; the adhesive layer comprises a syntactically foamed adhesive compound; the adhesive compound comprises one or more polymers selected from the group consisting of poly(meth)acrylates and synthetic rubbers; and the syntactically foamed plastic and the syntactically foamed adhesive compounds comprise a plurality of expanded microballoons.

The invention relates to a multilayer adhesive tape, to a process for producing a multilayer adhesive tape, to the use of a multilayer adhesive tape for producing bonds on medium and low surface energy substrates, and to the use of expanded microballoons in the carrier layer and the adhesive layer of an adhesive tape for increasing the low-temperature impact resistance.

The subject matter of the invention is defined in the appended claims.

The joining of separate elements is one of the central processes of manufacturing. In addition to other techniques, such as welding and soldering, for example, an important technique here nowadays is, in particular, adhesive bonding, i.e. joining with use of an adhesive. An alternative to the use of unshaped adhesives, which are applied from a tube, for example, is represented here by so-called adhesive tapes.

For numerous technical applications, particular relevance is possessed by pressure-sensitive adhesive tapes, in the case of which the bonding effect is provided by a pressure-sensitive adhesive (PSA) which is durably tacky and also adhesive under customary ambient conditions. Such pressure-sensitive adhesive tapes may be applied by pressure to a substrate and remain adhering there, but later can be removed again more or less free of residue.

Particularly in the field of vehicle manufacture, however, it is regularly necessary also to join components possessing what are known as low surface energy (LSE) or medium surface energy (MSE) surfaces. The bonding effect displayed by many pressure-sensitive adhesive tapes on such MSE/LSE surfaces is insufficient. This is relevant, for example, in the mounting of plastic parts of PP or PP/EPDM, which are coming increasingly to the fore in modern vehicles, owing to their positive processing properties and low materials costs, or in the mounting of painted components, which because of the paint system have a reduced surface energy. This steps up a level if these components, moreover, are to be used in the automobile exterior and are to be bonded there, correspondingly, to usually medium (MSE) to low surface energy (LSE) clearcoats or vehicle finishes, of the kind available from various manufacturers under trade names, for example, such as TMAC9000, Uregloss FF79 or Progloss FF99.

In order to ensure sufficient bonding to these MSE/LSE surfaces nevertheless, it is possible to subject the bond target surfaces—of plastic components or painted car parts, for example—to chemical and/or physical surface treatment prior to joining, in order to increase the surface energy and hence the bondability, this being done using adhesion promoters, for example. Because of the additional processing effort, however, these additional working steps are generally perceived to be disadvantageous and there is a requirement, therefore, to provide pressure-sensitive adhesive tapes which enable sufficient bonding to MSE/LSE surfaces without any additional surface treatment of the bond target substrates.

An improvement in the adhesion properties on untreated LSE surfaces may be achieved, for example, by using PSAs based on synthetic rubbers and/or poly(meth)acrylates. With such PSAs, it is frequently possible to achieve good to very good adhesion properties even on unpretreated, low surface energy surfaces.

There is a problem here, however, in that at least for pure synthetic rubbers and the adhesives obtained from them, properties of pressure-sensitive adhesiveness or intrinsic tack are per se not typical or, in the case of certain poly(meth)acrylates, are not sufficiently pronounced. In these adhesives, therefore, the effect of pressure-sensitive adhesiveness is frequently generated or boosted in a targeted way through the addition of what are called tackifier resins.

Particularly in light of the sometimes high concentration of tackifier resin, such PSAs generally have a comparatively high Tg, i.e., a high glass transition temperature. This limits the performance of such PSAs and of the pressure-sensitive adhesive tapes produced from them, at low temperatures. It has been found in particular that the resistance of such pressure-sensitive adhesive tapes to shock loading at low temperatures is often inadequate.

The problem described above is known in principle from the prior art and there have been various solutions proposed to counter this problem. For increasing the low-temperature impact strength in the context of adhesive tapes, DE 19730854 A1 discloses, for example, the use of foamed carrier layers coated on either side with unfoamed PSAs. As an alternative strategy, the prior art has also contemplated the use of a foamed or part-foamed PSA, which can be used on conventional unfoamed carrier materials or on carrier materials foamed with open porosity, as is disclosed in WO 2019/076652 A1.

Even if the solution approaches known from the prior art are able in many cases to lead to an improvement in the low-temperature impact resistance, it has emerged in practice that the results achievable with these approaches are for certain applications not sufficient, especially at particularly low temperatures, and that there is a need accordingly for further increase in the low-temperature impact resistance of pressure-sensitive adhesive tapes.

It was an object of the present invention, therefore, to eliminate the disadvantages of the prior art or at least reduce them and in particular to provide a multilayer adhesive tape which possesses an improved low-temperature impact resistance relative to the prior art, allowing particularly durable bonds to be generated even between substrates having medium to low surface energy surfaces, these bonds not failing even at low temperatures and in the face of severe impact loading.

A supplementary object of the present invention here was to specify a process for producing such multilayer adhesive tapes, that ought to be able, desirably, to be carried out using substances and techniques which are already employed in the field of adhesive technology, to enable easy adaptability of existing operations to the process.

Furthermore, the process to be specified ought to be able to be carried out in a time-efficient and cost-efficient manner and to permit high operational reliability.

The inventors of the present invention have now found that the above objects, surprisingly, can be achieved if, in contrast to the prior art, not only is foaming carried out of the adhesive or the carrier layer, but also, for an efficient solution to the problem, both the pressure-sensitive adhesive and the carrier layer have to be foamed.

This is also surprising inasmuch as, in line with the expectation of the skilled person, the foaming of pressure-sensitive adhesive layers leads per se to a reduction in the peel adhesion and hence in the adhesion on the substrate, as the proportion of pressure-sensitive adhesive components is reduced. In particular, since the failure mode of many PSAs in low-temperature impact tests is generally adhesive, it was not obvious that the adhesive failure in low-temperature impact tests can be reduced through the foaming of the two layers.

In this connection, it has emerged with particular surprise that not all types of foaming are equally suitable. Known from the prior art is the use of open-pored foams, polyethylene foam for example, and also the use of syntactically foamed plastics, in combination with unfoamed PSAs, for the carrier layer. In contrast to this, in the context of use of foamed PSAs on unfoamed carrier layers, it is usually syntactically foamed PSAs that are disclosed.

Regarding the production of syntactically foamed layers, the prior art has proposed a multiplicity of processes, an example being the use of hollow microspheres made of glass or ceramic. The inventors of the present invention, however, have now recognized that expanded microballoons must be used in both layers in order to achieve particularly advantageous low-temperature impact resistance when foamed carrier layers are combined with foamed PSAs.

A surprising finding, accordingly, was that in the systems identified by the inventors, hollow microspheres made of glass, for example, which in other systems have proven suitable for the production of syntactic foaming systems, do not afford satisfactory results in multilayer pressure-sensitive adhesive tapes of the invention.

Without wishing to be tied to this theory, it is assumed that when two foamed layers are used, i.e., a foamed carrier layer with a foamed PSA, the interaction at the boundary layer, also referred to as interlaminate adhesion, plays an important part for the overall low-temperature impact resistance, and that the adhesive interaction at the boundary layer is adversely affected if the foaming of one of the two layers is accomplished through hollow microspheres or other processes which do not represent syntactic foaming by expanded microballoons.

The objects identified above are therefore achieved by means of a multilayer adhesive tape, process for producing a multilayer adhesive tape, and uses, as defined in the claims. Preferred configurations according to the invention are apparent from the dependent claims and from the observations below.

In particularly preferred embodiments, features of subject matter of the invention that are referred to below as preferable are combined with other features referred to as preferable. Accordingly, combinations of two or more of the subjects referred to below as more preferable are especially preferable. Features of preferred processes and uses of the invention are apparent from the features of preferred multilayer adhesive tapes of the invention.

The invention relates to a multilayer adhesive tape, comprising a carrier layer and at least one adhesive layer disposed on the carrier layer, wherein the carrier layer comprises a syntactically foamed plastic, wherein the adhesive layer comprises a syntactically foamed pressure-sensitive adhesive, wherein the syntactically foamed pressure-sensitive adhesive comprises one or more polymers selected from the group consisting of poly(meth)acrylates and synthetic rubbers, and wherein the syntactically foamed plastic and the syntactically foamed pressure-sensitive adhesive comprise a multiplicity of expanded microballoons.

The concept of adhesive tape is clear to the person skilled in the art of adhesive technology. In the context of the present invention, the expression “tape” identifies all thin, sheetlike structures, i.e., structures having a predominant extent in two dimensions, more particularly films, film portions and labels, preferably tapes with extended length and limited width, and corresponding tape portions. An adhesive tape may be made available, for example, in rolled-up form as a roll of adhesive tape. Adhesive tapes generally comprises a carrier layer, on which an adhesive layer is disposed on one or both sides.

Preferred is a multilayer adhesive tape of the invention wherein the adhesive tape comprises two adhesive layers of syntactically foamed pressure-sensitive adhesive which are disposed on opposite sides of the carrier layer. Preferred also is a multilayer adhesive tape of the invention wherein the adhesive layer covers the carrier layer substantially completely.

In agreement with the understanding of the skilled person, a pressure-sensitive adhesive tape is an adhesive tape which possesses pressure-sensitive adhesive properties, i.e., possesses the property of entering into a durable bond to a substrate even under relatively weak applied pressure. After use, pressure-sensitive adhesive tapes are typically redetachable from the substrate substantially without residue and in general have a permanent intrinsic tack even at room temperature, meaning that they have a certain viscosity and contact adhesiveness, so that they wet the surface of a substrate even under low applied pressure.

The pressure-sensitive adhesiveness of a pressure-sensitive adhesive tape is a consequence of the use as adhesive of a pressure-sensitive adhesive (PSA). Without wishing to be tied to this theory, it is frequently assumed that a PSA may be regarded as a liquid of extremely high viscosity with an elastic component, which accordingly has characteristic viscoelastic properties leading to the above-described permanent intrinsic tack and pressure-sensitive adhesiveness. It is assumed that for PSAs of this kind, mechanical deformation results in processes of viscous flow and in the development of elastic forces of resilience. The viscous flow component here serves to achieve adhesion, whereas the elastic forces of resilience component is necessary in particular for the achievement of cohesion. The relationships between the rheology and the pressure-sensitive adhesiveness are known in the prior art and described for example in “Satas, Handbook of Pressure Sensitive Adhesives Technology”, third edition, (1999), pages 153 to 203.

The degree of elastic and viscous components is customarily characterized by employing the storage modulus (G′) and the loss modulus (G″), which may be ascertained by means of dynamic mechanical analysis (DMA), using a rheometer, for example, as is disclosed in WO 2015/189323, for example.

In the context of the present invention, an adhesive is preferably understood to have pressure-sensitive adhesiveness and hence to be a PSA if at a temperature of 23° C. in the deformation frequency range from 10⁰ to 10¹ rad/sec, G′ and G″ are each situated at least partly in the range from 10³ to 10⁷ Pa, with the storage modulus more preferably being situated, at a frequency of 0.1 rad/sec (0.017 Hz), in the range from 2*10⁵ to 4*10⁵ Pa.

A foamed material, whether it be the plastic or the PSA, refers to a structure composed of gas-filled, three-dimensional cells which are confined by liquid, semi-liquid, relatively high-viscosity or solid cell struts and which are present in a proportion such that the density of the foamed layer is reduced in relation to the density of the matrix material—that is, of the entirety of the non-gaseous materials of which the material is constructed.

In accordance with the invention, the carrier layer and the adhesive layer comprise a plastic and, respectively, a pressure-sensitive adhesive, each of which is syntactically foamed—that is, in which the foam cells are not bounded by the matrix material itself. Instead, in syntactic foams of these kinds, there are hollow spheres, of ceramic, polymer or glass, for example, incorporated in the matrix material, so that the cavities created are separated from one another and from the matrix material by a membrane.

In multilayer adhesive tapes of the invention, however, not all variants of syntactic foaming are relevant; instead, it is explicitly the case that the syntactically foamed plastic and the syntactically foamed PSA comprise a multiplicity of expanded microballoons. This means that the syntactic foaming is achieved at least partly through the use of expanded microballoons, with preferred multilayer adhesive tapes being those wherein the PSA and/or the plastic has been syntactically foamed exclusively by expanded microballoons, so that the carrier layer comprises a plastic syntactically foamed with microballoons and the adhesive layer comprises a PSA syntactically foamed with microballoons.

“Microballoons” refers to hollow microspheres having a thermoplastic polymer shell which are elastic and therefore expandable in their ground state. These spheres are usually filled with low-boiling liquids or liquefied gas. Shell material used comprises, in particular, polyacrylonitrile, PVDC, PVC or poly(meth)acrylates. Commonplace low-boiling liquids are, in particular, short-chain hydrocarbons, isobutane or isopentane for example, which are enclosed in the form of liquefied gas, for example, under pressure in the polymer shell.

Heating of the microballoons causes the outer polymer shell to soften. At the same time, the propellant substance disposed in the interior undergoes expansion. Here, the microballoons extend substantially irreversibly, and experience three-dimensional expansion. Expansion is at an end when the internal pressure matches the external pressure. As the polymeric shell is retained, the result is a closed-cell, syntactically foamed foam.

Microballoons which have not yet been thermally activated and which, accordingly, still have their original extent are referred to in the context of the present invention as unexpanded microballoons and, in agreement with the understanding of the skilled person, are not regarded as expanded microballoons.

Microballoons are available in a multiplicity of embodiments, which may be characterized essentially by way of their size (usually 6 to 45 μm diameter d50 in the unexpanded state) and their start temperatures needed for expansion (75 to 220° C.). Unexpanded microballoons are available, for example, as an aqueous dispersion with a microballoon mass fraction of around 40 to 45%, or as polymer-bound products, in ethylene-vinyl acetate, for example, with a microballoon mass fraction of around 65%. In the context of the present invention, however, it is preferred to use the unexpanded microballoons in powder form, with the powder preferably consisting substantially of the unexpanded microballoons.

The multilayer adhesive tape of the invention may be produced in principle either by adding already expanded microballoons to the plastic of the carrier layer and to the PSA, or by first adding unexpanded microballoons to both materials, these microballoons being subsequently converted by thermal exposure into expanded microballoons—the latter approach is explicitly preferred.

Because the properties and the morphology of microballoons are inherently dependent on the temperature used for expansion and on the ambient pressure, or the deformability of the matrix material, the present invention understands expanded microballoons to be microballoons which are at least partly expanded microballoons. This should be understood to mean that, relative to the unexpanded microballoons, the microballoons have been treated at a temperature greater than or equal to the respective start temperature for at least long enough for there to be a volume expansion, preferably a volume expansion by more than 25%, more preferably more than 50%, very preferably more than 100%, especially preferably more than 150%. This means that the expanded microballoons need not necessarily be fully expanded.

The skilled person knows that the temperature chosen for foaming the plastic or the PSA, respectively, is dependent on the desired foaming rate as well as on the nature of the microballoons. Continued foaming successively reduces the absolute density of the respective material. The state of the lowest density that can be achieved at a particular temperature for a particular material by foaming with expanding microballoons is referred to as full expansion, full foaming, 100% expansion or 100% foaming.

Although the precise definition of the expanded microballoons, as for all amorphous materials with properties critically determined by the operation used to produce them, may be challenging, the distinction between expanded and unexpanded microballoons is happily as simple for the skilled person in practice as the determination of full foaming, which, at least with an error tolerance that is acceptable in the sector, can be determined simply and reliably in practice.

In accordance with the invention, the PSA comprises one or more polymers selected from the group consisting of poly(meth)acrylates and synthetic rubbers. In the context of the present invention, the expression “poly(meth)acrylates”, in agreement with the understanding of the skilled person, embraces polyacrylates and polymethacrylates. It may be seen as an advantage of the multilayer adhesive tape of the invention that it is relatively flexible with regard to the PSA and that two types of particularly relevant PSAs may be used.

The PSA preferably comprises synthetic rubbers with a mass fraction of 40% or more, preferably 60% or more. The synthetic rubbers are preferably block copolymers, more particularly block copolymers preparable by polymerization of vinylaromatics, particularly styrene, and conjugated dienes having 4 to 18 carbon atoms, more particularly butadiene.

The PSA preferably comprises poly(meth)acrylate with a mass fraction of 40% or more, preferably 60% or more, more preferably 90% or more, with the PSA more preferably consisting substantially—apart from the expanded microballoons—of poly(meth)acrylate. The poly(meth)acrylates are preferably preparable by radical polymerization of acrylic acid and/or acrylic esters and/or methacrylic acid and/or methacrylic esters and also, optionally, further, copolymerizable monomers. More preferably the poly(meth)acrylates are preparable by radical polymerization of (meth)acrylic acid and/or butyl (meth)acrylate and/or ethylhexyl (meth)acrylate.

Preferred is a multilayer adhesive tape of the invention wherein the adhesive layer consists completely of the syntactically foamed PSA. While it is in principle possible to provide adhesives other than the syntactically foamed PSA in the adhesive layer, it is advisable, with a view to optimized low-temperature impact resistance, for the entire adhesive layer to be formed of the syntactically foamed PSA.

Preferred is a multilayer adhesive tape of the invention wherein the expanded microballoons are distributed substantially homogeneously in the PSA, with expanded microballoons more preferably having a diameter d50 in the range from 20 to 120 μm, preferably 15 to 80 μm, more preferably 20 to 40 μm. Also preferred is a multilayer adhesive tape of the invention wherein the expanded microballoons are distributed substantially homogeneously in the plastic, with the expanded microballoons more preferably having a diameter d50 in the range from 20 to 120 μm, preferably 15 to 80 μm, more preferably 20 to 40 μm. Corresponding multilayer adhesive tapes of the invention have the advantage that for the whole of the adhesive tape, a particularly uniform low-temperature impact resistance can be obtained, especially if the expanded microballoons are distributed substantially homogeneously not only in the PSA but also the plastic of the carrier layer. The stated diameters for the microballoons have proven in numerous in-house experiments to be particularly suitable for the generation of syntactically foamed materials. In particular, the peel adhesion of the pressure-sensitive adhesive layer and the stability of the carrier layer are compromised to a particularly small degree when such microballoons are employed.

In light of the fact that both the peel adhesion of the pressure-sensitive adhesive layer and the stability of the carrier layer may be adversely affected by the syntactic foaming, it has proven to be preferred, for certain applications, to limit the amount of expanded microballoons. Preferred accordingly is a multilayer adhesive tape of the invention wherein the PSA and/or the plastic comprise expanded microballoons in a mass fraction of 0.1 to 10%, preferably 0.2 to 5%, more preferably 0.5 to 2.5%, based on the total mass of the PSA and/or plastic.

It is in practice efficient for numerous applications for the multilayer adhesive tapes of the invention to be defined via the density of the pressure-sensitive adhesive layer or of the plastic, or by the degree of foaming thereof, since both variables are particularly readily determinable by the skilled person. These variables also make it possible to characterize the multilayer adhesive tapes of the invention which have been identified by the inventors as particularly highly performing in the course of the in-house trials.

Preferred is a multilayer adhesive tape of the invention wherein the adhesive layer and/or the PSA have a density in the range from 300 to 980 kg/m³, preferably 500 to 900 kg/m³, more preferably 650 to 800 kg/m³. Preferred analogously is a multilayer adhesive tape of the invention wherein the carrier layer has a density in the range from 300 to 980 kg/m³, preferably 400 to 800 kg/m³, more preferably 500 to 600 kg/m³.

Preferred is a multilayer adhesive tape of the invention wherein the degree of foaming of the PSA is in the range from 70 to 100%, preferably 80 to 100%, more preferably 90 to 100%, based on the full foaming at the start temperature of the microballoons. Preferred correspondingly is a multilayer adhesive tape of the invention wherein the degree of foaming of the syntactically foamed plastic is in the range from 70 to 100%, preferably 80 to 100%, more preferably 90 to 100%, based on the full foaming at the start temperature of the microballoons. More preferred are multilayer adhesive tapes of the invention wherein the PSA and the plastic have substantially the same degree of foaming.

The PSA may comprise one or more tackifier resins. In principle, the multilayer adhesive tapes of the invention are highly flexible in terms of the use of tackifier resin. In-house trials, though, have indicated that too high a proportion of tackifier resins, and an associated increase in the glass transition temperature, may disadvantageously affect the low-temperature impact resistance, resulting, at very low temperatures, even with multilayer adhesive tapes of the invention, in low-temperature impact resistance deemed not to be sufficient for certain applications.

Preferred is a multilayer adhesive tape of the invention wherein the pressure-sensitive adhesive comprises at least one tackifier resin, preferably with a mass fraction of 1 to 55%, more preferably 5% to 50%, very preferably 10 to 35%, if the PSA comprises a poly(meth)acrylate as main constituent, and preferably with a mass fraction of 10 to 70%, more preferably 15 to 60%, very preferably 20 to 50%, if the PSA comprises a synthetic rubber as main constituent.

The tackifier resin is preferably an apolar tackifier resin if the PSA comprises a synthetic rubber as main constituent. The tackifier resin is preferably an apolar or polar tackifier resin if the PSA comprises a poly(meth)acrylate as main constituent. The tackifier resin is preferably selected from the group consisting of unhydrogenated or partially or completely hydrogenated resins based on rosin or rosin derivatives, terpene-phenol resins, resins based on methacrylates, hydrogenated polymers of dicyclopentadiene, unhydrogenated or partially, selectively or completely hydrogenated hydrocarbon resins based on C₅, C₅/C₉ and C₉ mononomer streams, and polyterpene resins based on α-pinene and/or β-pinene and/or δ-limonene.

Preferred is a multilayer adhesive tape of the invention comprising a tackifier resin having a polydispersity of less than 2.1, preferably less than 1.8, more preferably less than 1.6 and/or comprising a tackifier resin having a softening point in the range from 90° C. to 120° C., more preferably in the range from 95° C. to 115° C.

According to the knowledge of the inventors, it is desirable, for the purpose of obtaining a multilayer tape of the invention that has particularly good processing qualities, to limit the thickness of the adhesive layer and/or of the carrier layer, but also not to make the two layers too thin, since to do so may cause problems with the syntactic foaming, so hindering production. It is advantageous here if the carrier layer is thicker than the adhesive layer.

Preferred is a multilayer adhesive tape of the invention wherein the adhesive layer has a thickness in the range from 20 to 250 μm, preferably 30 to 200 μm, more preferably 50 to 150 μm. Preferred is a multilayer adhesive tape of the invention wherein the carrier layer has a thickness in the range from 150 to 3000 μm, preferably 500 to 1500 μm, more preferably 700 to 1200 μm. Preferred also is a multilayer adhesive tape of the invention wherein the adhesive tape has a thickness in the range from 200 μm to 3000 μm, preferably 250 to 2000 μm, more preferably 500 to 1500 μm.

The multilayer adhesive tape of the invention has proven highly tolerant to the presence of additives in the adhesive layer. This is an advantage as it allows the physicochemical properties of the adhesive layer to be optimized without detracting from the positive effect of the invention on the low-temperature impact resistance.

Preferred is a multilayer adhesive tape of the invention wherein the PSA additionally comprises one or more additives selected from the list consisting of antioxidants (e.g., sterically hindered phenols, phosphites or thioethers), light stabilizers (e.g., sterically hindered amines), process stabilizers, UV absorbers, ageing inhibitors, rheological additives and fillers.

An advantage of the multilayer adhesive tapes of the invention is a particular flexibility with regard to the plastic used in the carrier layer, hence allowing the use of plastics also employed in conventional carrier materials. For the skilled person, accordingly, it is self-evident from the definition of the subject matter of the invention that the multilayer adhesive tape of the invention must necessarily comprise at least one plastic which can be foamed syntactically, although this is probably true of all industrially relevant plastics.

Preferred is a multilayer adhesive tape of the invention wherein the syntactically foamed plastic comprises a polymer selected from the group consisting of polyolefins, polyesters, poly(meth)acrylates, polyvinyl chloride and polyethylene terephthalate, preferably selected from the group consisting of polyethylene, polypropylene, poly(meth)acrylates and mixtures of these polymers, more preferably selected from the group consisting of poly(meth)acrylates, with the syntactically foamed plastic preferably consisting of the polymer. Preferred is a multilayer adhesive tape of the invention wherein the carrier layer is a viscoelastic carrier layer, with the carrier layer preferably consisting completely of the syntactically foamed plastic.

The PSA and/or the carrier layer preferably comprises poly(meth)acrylates which have been crosslinked using a crosslinker, preferably a divalent crosslinker. “Divalent crosslinker” means accordingly that the crosslinker possesses exactly two attachment points via which the connection to the polymer molecules that are to be crosslinked can be produced. Suitable crosslinkers are known to the skilled person on the basis of their art knowledge. The crosslinker may be, for example, a thermal crosslinker and/or a condensing crosslinker, and the participation of both kinds of crosslinkers in the crosslinking is also possible. More preferably, the crosslinker is a thermal crosslinker. Preferably, the poly(meth)acrylates of the PSA have been crosslinked using one or more epoxides or one or more substances containing epoxide groups.

More preferably, the PSA and/or the carrier layer comprises poly(meth)acrylates which have been crosslinked using a crosslinker-accelerator system (“crosslinking system”) in order thus to obtain better control over the processing time, the crosslinking kinetics and the degree of crosslinking. Suitable crosslinking systems are known to the skilled person on the basis of their art knowledge. The crosslinker-accelerator system preferably comprises at least one substance containing epoxide groups, as crosslinker, and at least one substance with an accelerating effect for crosslinking reactions via compounds containing epoxide groups at a temperature below the melting temperature of the polymer to be crosslinked, as accelerator. Amines are used more preferably as accelerators.

With a view to the processing properties in subsequent use, it has proven advantageous for a release material to be provided on the adhesive layers of the multilayer adhesive tapes of the invention. Such release materials, also referred to as release liners, are used, in the context of the adhesive tapes typically wound into Archimedean spirals, to prevent the various plies of the adhesive tapes sticking to one another, particularly in the case of double-sided adhesive tapes, and they ensure easy unwind. These release liners, which are removed from the adhesive before the adhesive tape is used, also ensure that the adhesive is not fouled by contaminants prior to application that might adversely affect the adhesive performance. Moreover, by adjusting the physical properties of the release materials, it is possible to adapt unwind behaviour of adhesive tape rolls to the mandates set for specific applications.

Preferred is a multilayer adhesive tape of the invention wherein the adhesive tape additionally comprises at least one release liner which is disposed on the adhesive layer, the release liner consisting preferably of one or more materials selected from the list consisting of thin glass, paper, plastic, metal and laminates of these materials, preferably selected from the list consisting of polyethylene-vinyl alcohol, polyethylene naphthalate, polyethylene, polypropylene, cycloolefin copolymers, polyvinylidene chloride, and metal foils or papers coated with these plastics.

To ensure efficient removal of the release materials from the underlying adhesives, release materials employed are frequently materials having on their surface a release coating, the release coating used frequently comprising crosslinkable silicone systems. In this context, the skilled person also refers to siliconization of the release materials or to a silicone release layer.

Preferred is a multilayer adhesive tape of the invention wherein the release liner, on the surface facing the adhesive layer, is preferably at least partly siliconized, with the siliconization being applied preferably with a dry weight of 0.1 to 5 g/m², more preferably 0.2 to 2.5 g/m², and preferably in a thickness in the range from 0.2 to 4 μm, more preferably in the range from 0.3 to 3 μm.

Preferred accordingly is a multilayer adhesive tape of the invention wherein the release liner comprises a silicone release layer, wherein the silicone release layer is producible by crosslinking a crosslinkable silicone system, wherein the crosslinkable silicone system comprises one or more polysiloxanes, wherein the crosslinkable silicone system is preferably curable thermally, more particularly curable with condensation or addition crosslinking, wherein the crosslinkable silicone system preferably comprises a crosslinking catalyst, wherein the crosslinkable silicone system is preferably applied from solution or from emulsion or as a solvent-free silicone system, preferably as a solvent-free silicone system. The crosslinking catalysts referred to above here comprise, for example, ruthenium, rhodium, palladium, osmium, indium or, in particular, platinum, complexes and compounds thereof, and/or catalyst systems composed of two or more of these catalysts.

In the production of multilayer adhesive tapes of the invention, it helps to achieve the goal if the materials components, especially the composition of the PSA and the selection of the expanded microballoons, are selected specifically in such a way as to achieve defined values when determining the low-temperature impact resistance. Preferred accordingly is a multilayer adhesive tape of the invention wherein the adhesive tape on determination of the low-temperature impact resistance under Ford Specification FLTM BU 109-02 achieves a value of 7 or more, preferably 8 or more, more preferably 9 or more, very preferably a value of 10.

Ford Specification FLTM BU 109-02 is familiar to the person skilled in the art of adhesive technology and represents an established method of evaluating low-temperature impact resistance. With this method, in each case 4 prepared test bars of polyvinyl chloride with the adhesive tapes under test are affixed to a painted or varnished plate and then conditioned at −29° C. for at least 4 hours. The plates are subsequently subjected a total of ten times to a controlled impact load. A record is made of how many impact loads the bonded system withstands without one of the test bars dropping. This number is recorded as the result, and so values of 10 correspond to a complete pass in the test.

The invention also relates to a process for producing a multilayer adhesive tape, preferably a multilayer adhesive tape of the invention, comprising the steps of:
a) producing or providing a starting plastic comprising a multiplicity of expandable microballoons, preferably unexpanded microballoons,
b) producing or providing a starting pressure-sensitive adhesive comprising one or more polymers selected from the group consisting of poly(meth)acrylates and synthetic rubbers, and also a multiplicity of expandable microballoons, preferably unexpanded microballoons, or a corresponding starting pressure-sensitive adhesive at least partly dissolved in solvent,
c) shaping the starting plastic with expansion of the expandable microballoons to form a carrier layer which comprises a syntactically foamed, preferably extrusion-shaped, plastic,
d) producing at least one adhesive layer comprising a syntactically foamed pressure-sensitive adhesive, comprising one of the steps of
i) shaping the starting pressure-sensitive adhesive with expansion of the expandable microballoons, or
ii) applying the starting pressure-sensitive adhesive at least partly dissolved in solvent to a carrier, more particularly a liner, drying and optionally crosslinking the starting pressure-sensitive adhesive dissolved in solvent, and lastly heating for the expansion of the expandable microballoons,
e) joining the carrier layer to the at least one adhesive layer, preferably double-sidedly joining the carrier layer to two adhesive layers.

Preferred accordingly are processes of the invention wherein at the instant of foaming, the layers produced are in double-sided contact with a carrier and/or with another layer so as to obtain extremely smooth surfaces in spite of the foaming of the expandable microballoons.

The starting plastic is preferably shaped in step c) already between two of the adhesive layers for production in step d). The carrier layer and/or the at least one adhesive layer are preferably subjected to corona treatment prior to the joining in step e).

It is thus also preferred for the shaping of the carrier layer in step c) and/or the joining in step d) to take place with a calender having two or more rolls, with the foamed carrier layer preferably being shaped in the calender between the already foamed layer of adhesive, in order thereby to join them.

As defined above, the starting PSA which serves as a starting point for the syntactically foamed PSA may be processed either directly from the melt (option i; also referred to as hotmelt) or from the solution (option ii); in the latter case, a corresponding starting PSA is used which is at least partly dissolved in solvent and which for the skilled person is easily produced.

In a typical solvent-based process, for example, all of the constituents of the starting PSA are dissolved in a solvent mixture such as benzine/toluene/acetone, for example. The expandable microballoons, for example, are suspended in benzine and incorporated by stirring into the dissolved PSA. For this it is possible in principle to use the known compounding and stirring assemblies, with care taken to ensure that the expandable microballoons do not yet expand during mixing, or at least not completely. As soon as the expandable microballoons are in homogeneous distribution in the solution, the starting PSA dissolved in solvent may be applied to the carrier, more particularly to a liner, and customary coating systems may be used here. Coating is possible, for example, by a doctor blade onto a conventional PET liner. In the next step, the coating is dried at 100° C. for 15 min, for example, to remove the solvent, and crosslinked where appropriate. In none of the aforesaid steps is there complete expansion of the expandable microballoons. After the drying, the adhesive layer thus generated is lined with a second ply of PET liner, for example, and is foamed in an oven in an appropriate temperature window, at 130 to 180° C. for example, to generate a particularly smooth surface.

In the case of the production of the adhesive layer from the melt, the expansion of the expandable microballoons is achieved typically through the temperature and residence time of the starting PSA in the extruder. In this case it is preferred if the constituents of the starting PSA, particularly the polymers and the expandable microballoons and also, where appropriate, further additives, are mixed in a mixing apparatus and heated to expansion temperature, so that the expandable microballoons already undergo at least partial expansion during mixing. The starting PSA together with the expanded microballoons is subsequently shaped to an adhesive layer in a roll applicator, and this adhesive layer may first be applied, for example, to a release material in web form. Alternatively or additionally, it may be advantageous here to set a positive pressure during mixing, so hindering the expansion of the expandable microballoons during mixing. In this case, expansion of the expandable microballoons occurs in particular on emergence from the mixing apparatus.

During the processing of already expanded microballoons, a possible situation is the floating of the microballoons in the pressure-sensitive adhesive or plastic into which they are to be incorporated, owing to their low density, so making it more difficult to achieve a fundamentally desirable homogeneous distribution of the expanded microballoons in the subsequent multilayer adhesive tape. In these cases, the concentration is higher in the upper region of the respective layer, thus setting a density gradient over the layer thickness. For this reason, the process of the invention provides for the intended use of microballoons that are still expandable, in other words as yet not completely expanded microballoons, and preferably, indeed, entirely unexpanded microballoons, in both materials intended for syntactic foaming. With this process, advantageously, particularly homogeneously foamed layers can be obtained. Moreover, with a view to interlaminate adhesion, it has proven particularly advantageous if the coating procedure, i.e., the production of the layer system, takes place ahead of the expansion of the microballoons.

Preferred is a process of the invention wherein the process is a continuous or a semicontinuous process, preferably a continuous process. It may be seen as a great advantage of the process of the invention that it is thereby possible to produce multilayer adhesive tapes of the invention in a continuous process.

In the light of the observations above, it is apparent to the skilled person that the invention also relates to the simultaneous use of expanded microballoons in the carrier layer and the adhesive layer of a multilayer adhesive tape, preferably a multilayer adhesive tape of the invention, for increasing the low-temperature impact resistance.

The invention, lastly, relates to the use of a multilayer adhesive tape of the invention for producing low-temperature-resistant bonds on medium and low surface energy substrates.

Medium and low surface energy substrates are understood in the context of the present invention to be substrates having a surface energy of <100 mJ/m², preferably of <50 mJ/m². Preferred low surface energy substrates are selected from the group consisting of painted surfaces, varnished surfaces, plastics surfaces, preferably selected from the group consisting of polyolefin surfaces (for example, PE, PP or PE/PP copolymer surfaces), ethylene-propylene-diene terpolymer (EPDM) surfaces, ABS (acrylonitrile-butadiene-styrene) surfaces, polycarbonate surfaces, and surfaces coated with clearcoats.

The invention is elucidated further, below, with reference to working examples.

Production of the Carrier Layers

A 100 l glass reactor conventional for radical polymerizations was charged with 1.5 kg of acrylic acid, 25.5 kg of butyl acrylate, 13.0 kg of 2-ethylhexyl acrylate and 26.7 kg of acetone/isopropanol (94:6). After nitrogen gas had been passed through the reactor for 45 minutes, with stirring, the reactor was heated up to 58° C. and 30 g of AIBN were added. The external heating bath was then heated to 75° C. and the reaction was carried out constantly at this external temperature. After a reaction time of 1 h, a further 30 g of AIBN (2,2′-azobis(isobutyronitrile)) were added. After 4 h and after 8 h, the batch was diluted on each occasion with 10.0 kg of acetone/isopropanol (94:6) mixture. To reduce the residual initiators, 90 g of bis(4-tert-butylcyclohexyl) peroxydicarbonate were added after 8 h and the same amount of said substance was added after 10 h. After a reaction time of 24 h, the reaction was discontinued and the batch was cooled to room temperature. The polyacrylate (AC) has a K value of 77.8, a solids content of 55.9%, an average molecular weight of Mw=1 040 000 g/mol, polydispersity D (Mw/Mn)=13.3, and a static glass transition temperature of Tg=−45.1° C.

The solvent was substantially removed from the polyacrylate (AC) thus produced (residual solvent content 0.3 wt %) using a single-screw extruder (concentrating extruder, Berstorff GmbH, Germany). The parameters for the concentration of the polyacrylate (AC) were as follows: the screw speed was 150 rpm, the motor current 15 A, and the realized throughput 58.0 kg/h on a liquid basis. For the concentration, a vacuum was applied at three different domes. The reduced pressures were each between 20 mbar and 300 mbar. The exit temperature of the concentrated hotmelt was around 115° C. The solids content after this concentration step was 99.8%.

The concentrated polyacrylate (AC) was melted in a feeder extruder and conveyed by this extruder in the form of a polymer melt, via a heatable hose, into a planetary roller extruder (PRE) from ENTEX (Bochum) (the PRE used in particular had four modules heatable independently of one another).

The concentrated polyacrylate (AC) was admixed with pentaerythritol tetraglycidyl ether (Polypox R16) as crosslinker. Where envisaged for an experiment, additional additives such as microballoons or hollow glass spheres were fed in via the metering port.

All of the components were mixed to give a homogeneous polymer melt.

By means of a melt pump, the respective polymer melt was transferred to a twin-screw extruder (from Berstorff). Triethylenetetramine (Epikure 925) was added as accelerator component. The mixture as a whole was cleared of all gas inclusions in a vacuum dome at a pressure of 175 mbar. Downstream of the vacuum zone, there was a blister on the screw that allowed a build-up of pressure in the subsequent segment. Through appropriate control of the extruder speed and of the melt pump, a pressure of greater than 8 bar was built up in the segment between blister and melt pump, and, where appropriate, microballoons or hollow glass beads were added and were incorporated homogeneously into the premix by means of a mixing element.

The resultant melt mixture was transferred into a die. After exit from the die, in other words after a drop in pressure, the microballoons, where incorporated, underwent expansion, with the drop in pressure resulting in a low-shear, more particularly shear-free, cooling of the polymer compound. In this way, an (optionally syntactically foamed) carrier layer was obtained which was subsequently coated either between two release materials, which can be used again after removal (process liners), and shaped to a web by means of a roll calender (off-line), or shaped to a web directly by means of a roll calender between the foamed PSA layers for application thereto (in-line).

Hollow glass spheres used were hollow glass spheres (HGS) having a diameter d50 of 21 μm (12-38 μm) which are available from Potters Industries under the trade name Sphericel 45P25. Microballoons (MB) used were microballoons available under the trade name Expancel 920DU40 (dry unexpanded microballoons; diameter 10-16 μm (d50), expansion start temperature 123-133° C.; TMA density≤17 kg/m³).

In further trials, in place of the above-produced carrier layer, a polyethylene foam having a density of 160 kg/m³ was used, which is available under the trade name SCHAUM WEISS D1100 TEE SRZ 0701.1 (PE foam).

Production of the Adhesive Layers:

Five different pressure-sensitive adhesives (PSAs) were produced by mixing of the individual components in a manner customary in the sector. Figures in % are understood as percent by mass, based on the total mass of the PSA. The trade names and CAS numbers of the compounds used are reported in parentheses where appropriate.
A 25% SBS (78 wt % two-block, block polystyrene content: 32 wt %; Kraton D1118, 9003-55-8), 25% SBS (16 wt % two-block, block polystyrene content: 31 wt %; Kraton D1101, 9003-55-8), 447% α-pinene resin (softening temperature: 115° C.; Dercolyte A115; 25766-18-1), 2% Pionier 2070 P, antioxidant 1% (Irganox 1010);
B 25% SBS (78 wt % two-block, block polystyrene content: 31 wt %; Kraton D1118, 9003-55-8), 25% SBS (radial, Calprene 411; 30% polystyrene content), 50% α-pinene resin (softening temperature: 115° C.; Dercolyte A115; 25766-18-1), antioxidant 1% (Irganox 1010);
C 80% acrylate constituent (5% acrylic acid, 47.5% butyl acrylate, 47.5% 2-ethylhexyl acrylate), 20% SBS (Calprene 7318; 31% block polystyrene content);
D 40% SBS (Calprene 4202, block polystyrene content 30%), 7% SBS (Calprene 7318; 31% block polystyrene content), 49% (Dercolyte A115), 3% hydrocarbon plasticizing resin (Wingtack 10), 1% antioxidant (Irganox 1010);
E 100% acrylate constituent (43% 2-ethylhexyl acrylate, 45% butyl acrylate, 12% acrylic acid).

In the experiments, these PSAs were used either unmodified or admixed beforehand with microballoons available under the trade name Expancel 920DU20 (dry unexpanded microballoons; diameter 5-9 μm (d50); expansion start temperature 120-145° C.; TMA density≤25 kg/m³). The microballoon (MB) content is reported below as percent by mass, based on the mass of the adhesive.

The adhesive layers were shaped from the starting PSAs dissolved in solvent, and applied to liners, by drying the solvent. Where necessary, the microballoons were expanded by heating.

Before the microballoons had been foamed, the skilled person does not yet refer to the system as a syntactically foamed adhesive. In the course of the present trials, the microballoons were foamed only in selected PSAs, to give syntactically foamed PSAs in the sense of the present invention.

As explained above, the three-layer systems investigated may be constructed in-line or off-line.

“In-line” here means that, while the syntactically foamed PSA layers are produced separately from the foamed carrier layer, the multilayer product is nevertheless constructed directly together with the shaping of the syntactically foamed carrier layer in a manner such that the carrier layer is shaped to a web between the PSA layers that are to be applied to it. Here, as an when necessary, the PSA layers are corona-treated immediately prior to application to the foamed carrier layer with a corona unit from Vitaphone, Denmark, at 70 W·min/m².

Conversely, “off-line” means that the carrier layer and the adhesive layer are first fully produced in isolation, then corona-treated with a corona unit from Vitaphone, Denmark, at 70 W·min/m², and subsequently laminated to one another, with these steps taking place at separate devices/stations.

The multilayer adhesive tapes, composed in each case of two adhesive layers and the carrier layer, were produced in the off-line process described above.

The multilayer adhesive tapes produced in the context of the present invention were subjected to determination of the low-temperature impact resistance according to the known Ford Specification FLTM BU 109-02. Here, in each case 4 prepared test bars of polyvinyl chloride with the adhesive tapes under test are affixed to a painted or varnished plate and then conditioned at −29° C. for at least 4 hours. The plates are subsequently subjected a total of ten times to a controlled impact load, and it is observed how many impact loads the bonded system withstands without one of the test bars dropping off. This number is recorded as the result, and so values of 10 correspond to a full pass in the trial.

The samples investigated and the results obtained for the determination of the low-temperature impact resistance (LTIR, as averaging over multiple measurements) are compiled in table 1 below, with d denoting in each case the thickness of the respective adhesive layers and/or carrier layers.

In table 1, the multilayer adhesive tapes with the numbers A4 to A7, B2 to B4, C₂, D1 to D3 and E2 are multilayer adhesive tapes according to the present invention.

The comparison of the results for the comparative adhesive tapes A1, A3 and A9 with the multilayer adhesive tapes of the invention illustrates that a better low-temperature impact resistance can be achieved if multilayer adhesive tapes are configured in accordance with the present invention. It is observed here that in particular with the multilayer adhesive tapes of numbers A6 and A7, it is possible to achieve very good low-temperature impact resistance despite the fact that the adhesive A used exhibits on average a comparatively poor low-temperature impact resistance.

Looking at the comparative samples with the numbers A2 and A8, it is clear that the advantages of the present invention are not observed if, instead of the expanded microballoons, hollow glass spheres are employed, although this does also result in syntactic foaming.

For the multilayer adhesive tapes of the invention which use the adhesives of type B, C, D or E, in particular, excellent low-temperature impact resistance is achieved in each case. It is consistently evident here that the low-temperature impact resistance obtained for multilayer adhesive tapes of the invention is significantly improved relative to the adhesive tapes for which at least one layer is not foamed.

Accordingly, the experimental results illustrate that, with multilayer adhesive tapes of the invention, particularly advantageous low-temperature impact resistance can be achieved.

TABLE 1

| | Adhesive | | | | Carrier layer | | | | |
|---|---|---|---|---|---|---|---|---|---|
| No. | Type | Addition | Status | d/μm | Type | Addition | Status | d/μm | LTIR |
| A1 | A | — | unfoamed | 50 | AC | MB | foamed | 1000 | 0.0 |
| A2 | A | — | unfoamed | 50 | AC | GHS | foamed | 1000 | 0.0 |
| A3 | A | 1.5% MB | unfoamed | 50 | AC | MB | foamed | 1000 | 0.0 |
| A4 | A | 1.5% MB | foamed | 50 | AC | MB | foamed | 1000 | 2.0 |
| A5 | A | 1.0% MB | foamed | 50 | AC | MB | foamed | 1000 | 1.3 |
| A6 | A | 1.5% MB | foamed | 150 | AC | MB | foamed | 1000 | 8.8 |
| A7 | A | 1.0% MB | foamed | 150 | AC | MB | foamed | 1000 | 7.0 |
| A8 | A | 1.5% MB | foamed | 150 | AC | GHS | foamed | 1200 | 0.5 |
| A9 | A | 1.5% MB | foamed | 150 | AC | — | unfoamed | 1000 | 1.0 |
| B1 | B | 1.5% MB | unfoamed | 50 | AC | MB | foamed | 1000 | 0.0 |
| B2 | B | 1.5% MB | foamed | 50 | AC | MB | foamed | 1000 | 10.0 |
| B3 | B | 1.0% MB | foamed | 70 | AC | MB | foamed | 1000 | 7.5 |
| B4 | B | 1.5% MB | foamed | 70 | AC | MB | foamed | 1000 | 10.0 |
| B5 | B | 1.5% MB | unfoamed | 70 | PE foam | — | foamed | 1050 | 3.8 |
| B6 | B | 1.5% MB | foamed | 70 | AC | — | unfoamed | 1000 | 5.0 |
| C1 | C | 1.2% MB | unfoamed | 100 | AC | MB | foamed | 1000 | 6.8 |
| C2 | C | 1.2% MB | foamed | 100 | AC | MB | foamed | 1000 | 10.0 |
| D1 | D | 1.5% MB | foamed | 150 | AC | MB | foamed | 700 | 3.8 |
| D2 | D | 2.5% MB | foamed | 150 | AC | MB | foamed | 700 | 9.0 |
| D3 | D | 1.5% MB | foamed | 70 | AC | MB | foamed | 1000 | 10.0 |
| E1 | E | — | unfoamed | 50 | AC | MB | foamed | 1000 | 3.0 |
| E2 | E | 0.9% MB | foamed | 50 | AC | MB | foamed | 1000 | 10.0 |

1. A multilayer adhesive tape, comprising a carrier layer and at least one adhesive layer disposed on the carrier layer,
wherein the carrier layer comprises a syntactically foamed plastic,
wherein the adhesive layer comprises a syntactically foamed pressure-sensitive adhesive,
wherein the syntactically foamed pressure-sensitive adhesive comprises one or more polymers selected from the group consisting of poly(meth)acrylates and synthetic rubbers, and
wherein the syntactically foamed plastic and the syntactically foamed pressure-sensitive adhesive comprise a multiplicity of expanded microballoons.

2. The multilayer adhesive tape of claim 1, wherein the pressure-sensitive adhesive comprises at least one tackifier resin.

3. The multilayer adhesive tape of claim 1, wherein the syntactically foamed plastic comprises a polymer selected from the group consisting of polyolefins, polyesters, poly(meth)acrylates, polyvinyl chloride, and polyethylene terephthalate.

4. The multilayer adhesive tape of claim 1, wherein the pressure-sensitive adhesive comprises synthetic rubbers with a mass fraction of 40% or more and/or wherein the pressure-sensitive adhesive comprises poly(meth)acrylate with a mass fraction of 40% or more.

5. The multilayer adhesive tape of claim 1, wherein the pressure-sensitive adhesive and/or the plastic comprise expanded microballoons in a mass fraction of 0.1 to 10%.

6. The multilayer adhesive tape of claim 1, wherein the degree of foaming of the pressure-sensitive adhesive and/or of the plastic is in the range from 70 to 100%, based on a full foaming at a start temperature of the microballoons.

7. The multilayer adhesive tape of claim 1, wherein the adhesive tape on determination of a low-temperature impact resistance under Ford Specification FLTM BU 109-02 achieves a value of 7 or more.

8. A process for producing a multilayer adhesive tape comprising the steps of:
a) producing or providing a starting plastic comprising a multiplicity of expandable microballoons,
b) producing or providing a starting pressure-sensitive adhesive comprising one or more polymers selected from the group consisting of poly(meth)acrylates and synthetic rubbers, and also a multiplicity of expandable microballoons, or a corresponding starting pressure-sensitive adhesive at least partly dissolved in solvent,
c) shaping the starting plastic with expansion of the expandable microballoons to form a carrier layer which comprises a syntactically foamed plastic,
d) producing at least one adhesive layer comprising a syntactically foamed pressure-sensitive adhesive, comprising one of the steps of
i) shaping the starting pressure-sensitive adhesive with expansion of the expandable microballoons, or
ii) applying the starting pressure-sensitive adhesive at least partly dissolved in solvent to a carrier, drying and optionally crosslinking the starting pressure-sensitive adhesive dissolved in solvent, and lastly heating for the expansion of the expandable microballoons, and
e) joining the carrier layer to the at least one adhesive layer.

9. A method of using expanded microballoons in a carrier layer and an adhesive layer of a multilayer adhesive tape for increasing the low-temperature impact resistance.

10. A method of producing a low-temperature-resistant bond on a medium or low surface energy substrate, said method comprising applying a multilayer adhesive tape according to claim 1 to the substrate.

11. The multilayer adhesive tape of claim 2, wherein the pressure-sensitive adhesive comprises a poly(meth)acrylate as main constituent, and the tackifier resin has a mass fraction of 1 to 55%.

12. The multilayer adhesive tape of claim 2, wherein the pressure-sensitive adhesive comprises a synthetic rubber as main constituent, and the tackifier resin has a mass fraction of 10 to 70%.
